(19) United States
(12) Patent Application Publication
(10) Pub. No.: US 2021/0361003 A1
(43) Pub. Date: Nov. 25, 2021

(54) FASTENER FORMED FACE MASK

(71) Applicant: Zootility Co., Portland, ME (US)

(72) Inventor: Nathan Barr, Portland, ME (US)

(21) Appl. No.: 17/326,577

(22) Filed: May 21, 2021

Related U.S. Application Data
(60) Provisional application No. 63/028,479, filed on May 21, 2020.

(51) Int. Cl. A41D 13/11

(52) U.S. Cl. CPC A41D 13/1161; A41D 13/1115; A41D 2300/328; A41D 2300/324; A41D 2300/32

(57) ABSTRACT

Fastener formed face masks are provided including a flat fabric article having a first end, a second end and a central axis, a first fastener pair positioned between the first end and the central axis, and a second fastener pair positioned opposite the first fastener pair between the second end and the central axis, wherein the fastener formed face mask is predominantly flat in an unfastened position of both the first and second fastener pairs, and wherein the fastener formed face mask is cupped for fitting to a face of a wearer in a fastened position of both the first and second fastener pairs.

### CROSS-REFERENCE TO RELATED APPLICATION(S)

This application claims priority to U.S. Provisional Application No. 63/028,479 filed May 21, 2020, entitled “FASTENER FORMED FACE MASK,” which is incorporated herein by reference in its entirety.

### FIELD OF THE INVENTION

The present invention generally relates to universal face masks, both for the benefit of the wearer and those in proximity to the wearer. The masks are formed into a complex shape by folding fabric and holding the shape in place with optional fasteners. The masks optionally include one or more replaceable filters.

### BACKGROUND OF THE INVENTION

In the area of face masks or face coverings, there are many designs that follow similar sew patterns that are hand sewn, sewn using industrial sewing machines, or no sewn designs. Overall, global face mask market is comprised on different types of face masks: hospital mask, dental mask, industrial mask, veterinary mask, and others.

Face masks reduce the risk of transferring infectious bacteria, virus and the like between one person to another or in any context where nose, mouth and eye protection may be indicated. Face masks cover an area over the mouth of the wearer.

The common type of fabric used in many face masks and face coverings is typically soft lightweight fabric. Face masks made from spandex, neoprene, or other similar synthetic material are not common in the face masks market.

On the functional side, formed masks, when fitted properly, provide a close fit to the face to prevent air from bypassing the mask filter material. N95 masks, and other small-particle masks, have a formed cup shape to provide ample breathing room. Many medical and construction masks come with a metallic nose bridge element which is bent by the wearer into the custom shape of the nose. Masks are attached to the face either through a single or dual band around the head or two loops that fit behind the wearer's ears. Latex free elastics are an important requirement for healthcare settings.

Nonetheless, there exists a need for face masks that provide an effective barrier to air-borne contaminants such as bacteria and viruses between one wearer and another wearer in public spaces, while still providing for improved design. Making use of materials not commonly used in mask making also aids in supply during times of high demand for masks made from more common materials.

### SUMMARY OF THE INVENTION

The invention disclosed herein overcomes some of the shortcomings of the prior art by disclosing a flat pattern that requires no sewing but can be folded to form a cup shape to provide a good seal to the face. The folding can be held in place with the use of a permanent or releasable fastening mechanism. In the case of a releasable fastening mechanism, the flat nature of the pattern allows for the mask to be thoroughly cleaned, without any folds or stitches to capture and retain contamination.

The secondary benefit of the releasable fastening mechanism is that it allows other layers to be releasably connected to the face mask. This is particularly useful with single-use disposable filter layers. Many non-woven materials can not be cleaned, as washing damages the filter structure and reduces the efficacy of the filter to capture microbes and particulates.

This hybrid approach—of a reusable mask housing a disposable filter—allows the outer mask to be cleaned between exposures with only the inner filter needing to be replaced. It uses less material and is faster to produce than a fully disposable mask. Further, even the reusable portion of the proposed design of the mask can be made from minimal material and assembly effort, for maximum scalability and minimal reliance on suppliers to manufacture the final product.

The folding of a semi-rigid material in the face mask allows the cup shape to hold the formed shape and not collapse in on the face of the wearer. The semi-rigid material can be the outer layer itself if made of a material that while stretchy also exhibits some stiffness, for example 1.5 mm stretchy neoprene. It could be a lighter, thinner fabric with a tight weave. It can also be the disposable inner filter layer, if that filter material has a reasonable rigidity, for instance >60 gsm (grams per square meter) non-woven spunbonded polypropylene. In addition, a half twist of 180 degrees on each ear loop when donning the face mask provides compressive forces on the face of the wearer, on top of the nose bridge and under the chin. This compression comes from the tension in the material on top of the nose being pulled under the bottom of the ear and the tension in the material under the chin being pulled over the top of the ear. Both tension forces are enhanced, and in most cases created by, the half twist applied to each ear loop. The compressive forces enhance the seal of the mask to the face of the wearer. The folding of the semi-rigid material in the face mask can be configured to create a shape that matches the shape formed by the mask when donned with a half twist in each ear loop.

Alternatively, an additional layer can be added to the face mask that is reusable. The semi-rigid layer made from denim, cotton twill, duck canvas, or similar material can have the added benefit of improving the filtration efficacy while also supporting the face mask shape away from the wearer's face. These materials often experience fraying along the edges unless the weave ends are captured. Ways of capturing the weave ends of the fabric along the edges include: overlock stitching (serger stitch), taping, gluing, bonding interfacing, melting, folding, and hemming.

When a semi-rigid layer is added as an inner layer, it allows the outer stretchy layer to apply compressive force on the face mask, including the semi-rigid layer, to provide a good seal of the mask to the wearer's face. This has been found by researchers at Northeastern University to maximize the airflow through the mask, instead of around the edges of the mask, greatly improving the efficacy. The team, led by Loretta Fernandez, found that a 3M surgical mask went from blocking 75% of small particles to 90% with the addition of a tight outer stretchy layer.

In some embodiments, the face mask comprises an outer layer of stretchy fabric, for example a 94% polyester/6% spandex blend with a weight of 230 gsm and an inner layer of a nonwoven semirigid filter material, for instance spunbonded polypropylene with a weight of 60 gsm. The two pieces are cut using a die press, die roll, fabric cutter, laser cutter, digital cutter, or other similar means. The pattern includes four small holes for releasable fastening mechanisms, such as button snaps, to be attached through the holes for quick assembly with accurate placement. Each side of the face mask has two holes that axially align when folded into the desired shape. A single fastening mechanism is then inserted into the aligned holes. The outer layer being a synthetic fabric allows for a laser to cut the material and melt the edges at the same time, preventing fraying to some degree.

The use of a single fastening mechanism for the hole pair on each side of the mask can be repurposed for releasably attaching the inner filter material to the inside of the face mask.

In an additional embodiment, the releasable fastening mechanism is button snaps where each half of one button snap assembly is press fit through each of the two hole pairs. This forms two separate button snap sets on each side of the face mask that, when connected, fold the fabric symmetrically across the left and right side of the wearer's face. The resulting shape is a cup that stands out from the mouth for comfort. It also creates a shape that fits the standard curves of a face, creating a tight fit to the nose bridge without the need for a metallic shaping wire while simultaneously creating a tight fit to the cheeks and chin.

In using a pair of button snaps, the filter material is releasably attached to the face mask by the addition of two holes on each side of the filter, or two hole pairs, that line up with the button snaps. In this way, the inner layer is folded in a similar fashion to the outer layer. It also allows the filter material to be captured by axially aligning and inserting the filter holes onto the button snaps before closing the button snaps shut. Alternatively, the filter could have a single hole on each side of the mask to simplify the insertion process, so that it is fully captured while still reasonably positioning the filter in the mask.

In an alternate embodiment, the face mask has additional holes that the fastening mechanism connects through, either releasably or permanently. This allows the mask to curve further and reach tightly under the chin of the wearer. When releasably, such as with button snaps, the fastening mechanism is first press fit into certain holes, then lined up with additional holes through which the button snaps are fastened. When permanently, multiple holes are lined up before the button snap halves are press fit in position, thus capturing two or more holes with one button snap half. Fastening the button snap completes the forming of the mask shape.

In an additional embodiment, the inner layer is a washable layer, such as denim, stretchy denim, cotton twill, jersey cotton, neoprene, double knit, ponte di roma, or synthetic blend. Heavier fabrics have been shown to still have a reasonable ability to capture small particles.

In a further embodiment, the inner washable layer is a twill denim of 8 oz weight (270 gsm) with a blend of 71% cotton, 27% polyester, and 2% spandex.

In an additional embodiment, the outer layer is a 4-way stretch fabric of 80% nylon and 20% spandex with a weight of 200 gsm.

In an additional embodiment, the inner filter layer is a melt-blown polypropylene with a weight between 20-34 gsm.

In an further embodiment, the inner filter layer of melt-blown polypropylene is in addition to a second or third inner layer.

In some embodiments, the face mask attaches behind the wearer's ears. This can be with a single loop, on each side of the mask, that is sized to fit a range of head shapes and sizes. Multiple mask sizes could be offered for different head sizes. Alternatively, the ear loops could be adjustable to be sized by the wearer to fit the full range of head sizes. This could be accomplished with slits or holes in the ear loop through which the releasable fastening mechanism could be closed.

In an alternate embodiment, the face mask has a band that wraps around the head of the wearer. This would have the benefit of not putting pressure on the back of the ears. If the band were elastic, it can stretch to accommodate a range of head sizes and shapes. There could additionally be elongated ear holes in the band that allow the wearer to keep the mask firmly in place on the wearer, using the tops of the ears, but not the backs of the ears, where the elongation allows the mask to fit a variety of head sizes.

In a further embodiment, the band is adjustable to be sized to the size of the head of the wearer. With two ends of the band, one on either side of the fask mask, this could possibly be done by simply twisting or tying the two ends together and pulling tight to the appropriate fit.

In an alternate embodiment, the band that wraps around the head of the wearer is integral to the outer layer of the face mask. This could be made from the same piece of fabric and simply be part of the pattern for the outer layer.

In a further embodiment, the outer layer that wraps around the head of the wearer could overlap in the front of the face, so that the outer layer also comprises the inner layer. In such a way, the releasable fastening mechanism could be the element that either permanently or releasably attaches the inner part to the outer part of the wrap.

In a further embodiment, an additional inner layer of filter material could be applied permanently or releasably. When attached releasably, it could be captured by axially aligning holes with the locations of the fastening mechanism and closing the fastening mechanism trapping the filter layer in the mask.

In an alternative embodiment, the inner and outer part of the wrap could create a pocket into which an additional filter layer could be inserted. The space between the two layers could be the pocket, or the outer or inner layer could be folded over to create the pocket out of that layer.

In an alternate embodiment, the face mask has more than one band that wraps around the head of the wearer to keep the mask in place. This would have the benefit of allowing the mask to be best positioned on the face of the wearer and apply more even pressure to keep the mask sealed well to the face.

In a further embodiment, the more than one bands that wrap around the head of the wearer are adjustable in length. This would also allow for better fitting the mask to the face with potentially improved wearer comfort.

### BRIEF DESCRIPTION OF THE DRAWINGS

FIG. 1 is a front view of an exemplary face mask described herein shown over the face of a wearer. The face mask includes a releasably attached replaceable filter inner layer.

FIG. 2 is a side view of the mask of FIG. 1.

FIG. 3 is a front view of the mask of FIG. 1 shown folded flat with the fastener pair in the unfastened position.

FIG. 4. is a back view of the mask of FIG. 3 shown folded flat with the fastener pair in the unfastened position.

FIG. 5. is a back view of the mask of FIG. 3 shown with the fastener pair in fastened position.

FIG. 6 is the front view of the mask of FIG. 3 showing the fastening components being assembled onto the outer layer of the mask.

FIG. 7 is the back view of the mask of FIG. 4 showing the inner layer being inserted into the outer layer.

FIG. 8 is a front view of another exemplary face mask described herein shown over the face of a wearer. The face mask includes a permanently attached washable inner layer.

FIG. 9 is a side view of the mask of FIG. 8.

FIG. 10 is a font view of the mask of FIG. 8 shown folded flat with the fastener pair in the unfastened position.

FIG. 11 is a back view of the mask of FIG. 10 shown folded flat with the assembly exploded to show each individual component.

FIG. 12 is a back view of the mask of FIG. 10 shown folded flat with the fastener pair in the unfastened position.

FIG. 13 is a back view of the mask of FIG. 12 shown with the fastener pair in fastened position.

FIG. 14 is the front view of another exemplary face mask described herein shown folded flat with the fastener pair in the unfastened position. The face mask includes adjustable straps that comprise the ear loops, where the straps have a plurality of slits to accommodate size adjustment.

FIG. 15 is a side view of the mask of FIG. 14.

FIG. 16 is a back view of the mask of FIG. 14 shown folded flat with the assembly exploded to show each individual component.

FIG. 17 is the front view of the mask of FIG. 16 shown folded flat, assembled, with the fastener pair in the unfastened position.

FIG. 18 is the back view of the mask of FIG. 16 shown folded flat, assembled, with the fastener pair in the unfastened position.

FIG. 19 is the back view of the mask of FIG. 18 shown with the fastener pair in the fastened position.

FIG. 20 is the front view of another exemplary face mask described herein shown over the face of a wearer. The face mask is a single layer that includes elongated ear holes and two ends that can be fastened by twisting or tying together behind the head of the wearer.

FIG. 21 is the side view of the mask of FIG. 20.

FIG. 22 is the back view of the mask of FIG. 20.

FIG. 23 is the front view of the mask of FIG. 20 shown folded flat.

FIG. 24 is the front view of another exemplary face mask described herein shown over the face of a wearer. The face mask is an outer layer that includes elongated ear holes and two ends that can be fastened by twisting or tying together behind the head of the wearer, with a fastener mechanism that attaches an inner layer and folds the mask into a cup shape.

FIG. 25 is the side view of the mask of FIG. 24.

FIG. 26 is the back view of the mask of FIG. 24.

FIG. 27 is the front view of the mask of FIG. 24 shown folded flat with the fastener pair in the unfastened position.

FIG. 28 is a back view of the mask of FIG. 27 shown folded flat with the fastener pair in the unfastened position.

FIG. 29 is a back view of the mask of FIG. 28 shown with the fastener pair in fastened position.

FIG. 30 is a back view of another exemplary face mask described herein shown in an exploded assembly. The face mask is similar to the mask in FIG. 24, but with the addition of a second, lower fold cupping the mask further under the chin.

### DETAILED DESCRIPTION OF THE INVENTION

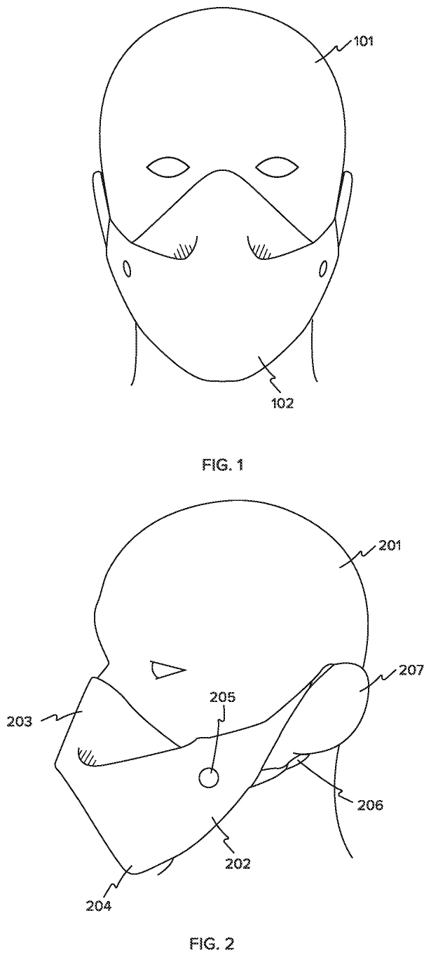

The present invention is directed towards an improved design of and manufacturing techniques for a face mask. With reference to FIG. 1, a person 101 is shown wearing a mask 102 as one embodiment of the present invention that has an outer semi-rigid layer and an inner replaceable filter layer.

As seen in FIG. 2, the same mask 202 shown on the side profile of the wearer 201, has a nose bridge 203 and extends down to a chin cover 204. It is formed by fastening a fastening mechanism 205, shown in this embodiment as a button snap, on each side of the mask. The ear loop 206 is placed around the ear 207 to secure the mask to the face of the wearer 201. A half twist of 180 degrees in each ear loop 206 when the wearer dons the face mask 202, creates a tighter seal to the face by pulling the nose bridge 203 tight and the chin 204 tight by the tension in the two straps, over and under the ear 207, of the ear loop 206.

In FIG. 3, the front of the same embodiment of the mask outer layer 302 is shown folded flat with the fastening mechanism 205 of FIG. 2 now shown in the unfastened position. The fastening mechanism is comprised of a lower button snap 305 and upper button snap 308. There are two pairs of the button snaps, shown on the left and right side of the mask outer layer 302. The mask is comprised of two layers, the outer layer 302 and the inner layer 309, shown from the front by the two tabs that reach over the edge from the back to the front and fold over the upper button snaps 308.

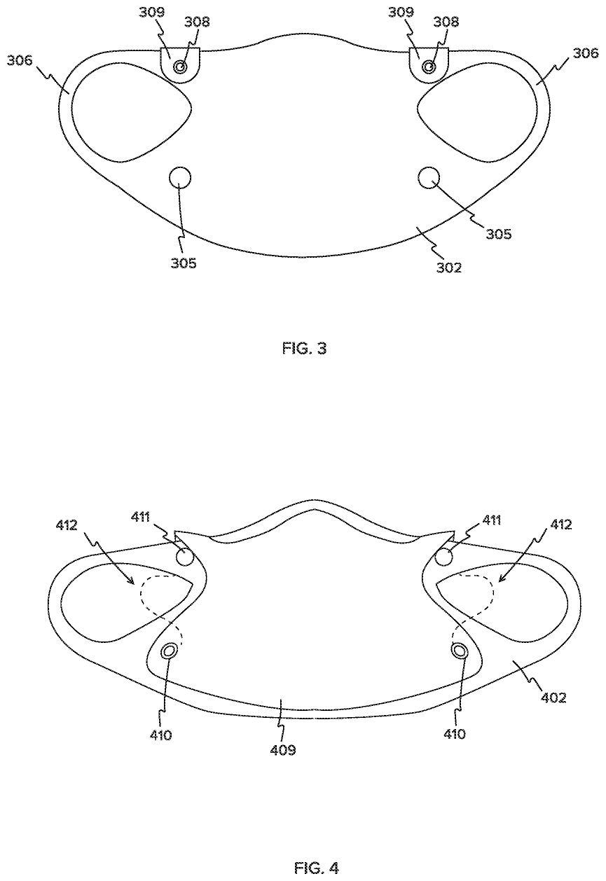

When viewed from the back, as shown in FIG. 4, the mask inner layer 409 can be seen to be temporarily placed over the back of mask outer layer 402. The inner filter layer 409 is shown with the pass through hole aligned to the button snaps. When fastening the button snaps, the upper button snap 411 follows the path 412 to connect to the lower button snap 410.

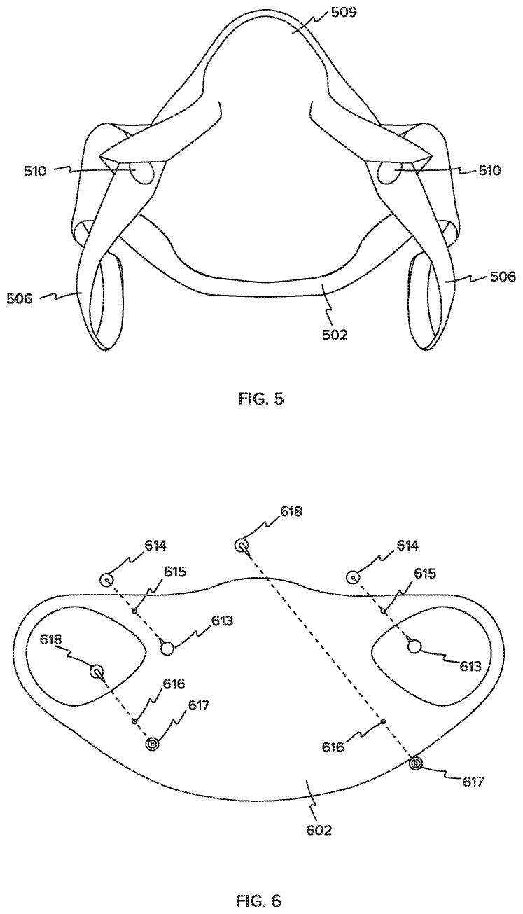

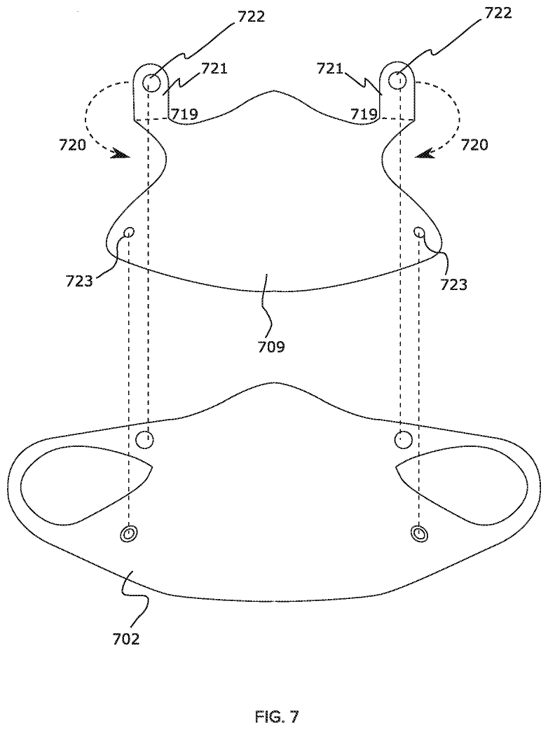

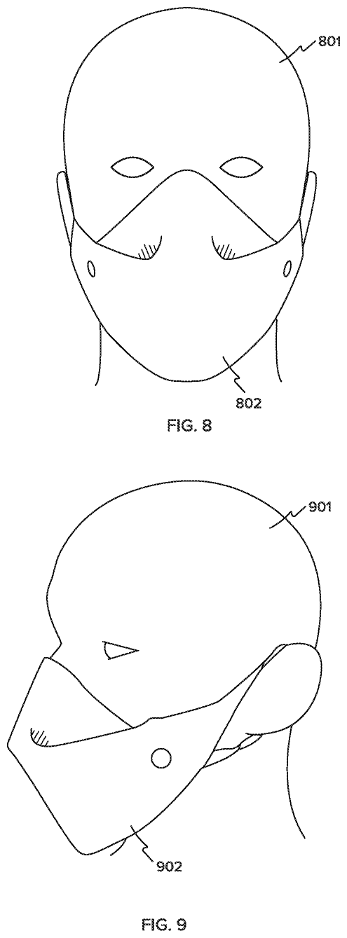

As seen in FIG. 5, when the mask is folded into the desired shape for wearing and the fastening mechanism—the button snaps—are in the fastened position, the inner layer 509 is affixed to the outer layer 502. This is accomplished by trapping the pass through holes in the closed button snaps, which now that the upper and lower button snaps are releasably connected, only the upper button snap 510 is visible. The wearer dons the mask as would be most natural, placing the ear loops 506 around the ears. By the nature of the mask folding to allow the upper button snap to connect to the lower button snap, following path 412, the ear loops 506 have been given a 180 degree twist from their position when the mask is folded flat.

As seen in FIG. 6, the outer layer of the mask 602 has an upper hole set 615 and a lower hole set 616. The fastener mechanism is permanently affixed to the outer layer of the mask 602, by press fitting the male and female components of the large and small button snap pair. One the upper hole, the male button snap component 613 is inserted through and press fit onto the small female button snap component 614. On the lower hole, the male button snap component 618 is inserted and press fit onto the large female button snap component 617. The large and small female components are interchangeable in their position of upper and lower holes, but must be paired together to fasten. The press fitting action is accomplished with the use of an installation tool, typically a press or pliers.

The inner filter layer 709 is inserted into the mask outer layer 702 by aligning the upper holes 722 and lower holes 723 on both the left and right sides of the mask. The upper holes 722 are aligned when the inner filter upper tabs 721 are folded down along the folding line 719. The filter layer tabs 721 are optional. If they are not included in the embodiment, the inner filter layer 709 only attaches by having the lower holes 723 align with the fastening mechanism passing through the holes and fastening to trap the inner layer 709 to the outer layer 702.

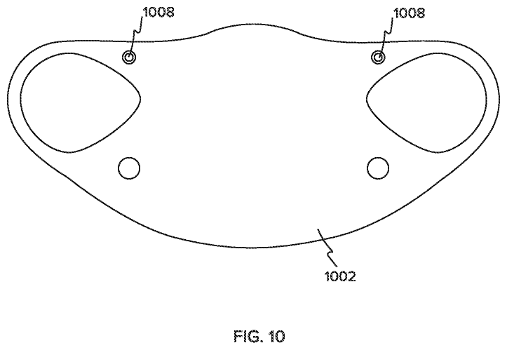

A separate embodiment of the mask is shown in FIG. 9 on the wearer 901, where the inner layer is permanently connected to the outer layer 902. From the side view, the inner layer is not visible, and is indistinguishable from FIG. 2. As seen in FIG. 10, when the mask is unfolded and the outer layer 1002 is flat and viewed from the front, the inner layer is still not visible. This is unlike the mask embodiment of FIG. 3, where the inner layer tabs 309 are visible. On the mask in FIG. 10, the upper fastening mechanism 1008 can be seen but there are no tabs from the inner layer on the front side of the mask.

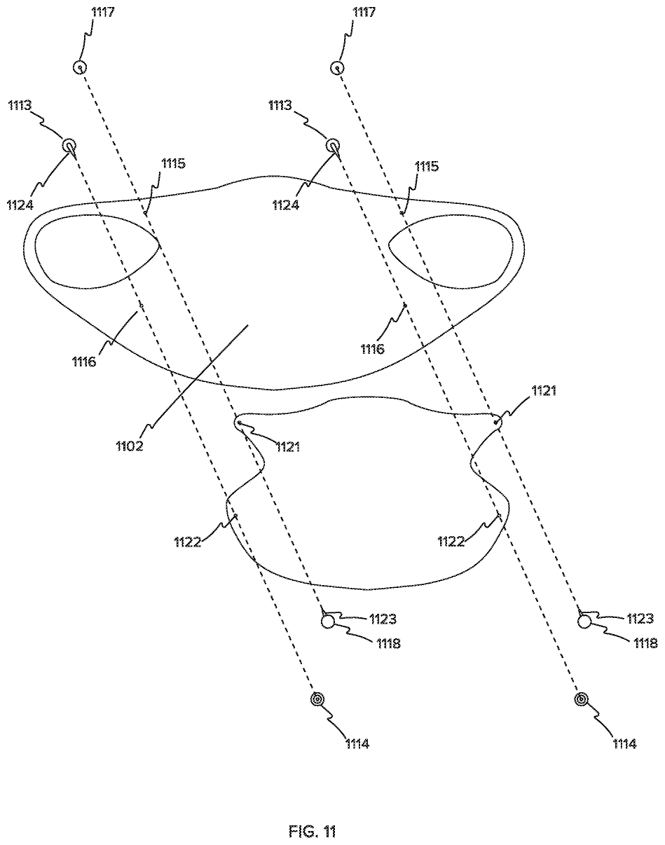

As seen in FIG. 11, this same embodiment can be viewed as an exploded assembly to demonstrate the components of the fastening mechanism, shown here as button snaps. The button snaps are comprised of a small upper snap assembly and a large lower snap assembly that releasably fastening together. The upper assembly is formed by inserting the spike 1123 from the male component 1118 through the inner layer upper hole 1121, through the outer layer upper hole 1115, through the small female snap 1117 and pressing with an installation tool to deform the spike 1123 into a flat shape that cannot be withdrawn from the small female snap 1117. The lower assembly is formed by inserting the spike 1124 from the male component 1113 through the outer layer lower hole 1116, through the inner layer lower hole 1122, through the large female snap 1114 and pressing with an installation tool to deform the spike 1124 into a flat shape that cannot be withdrawn from the large female snap 1114.

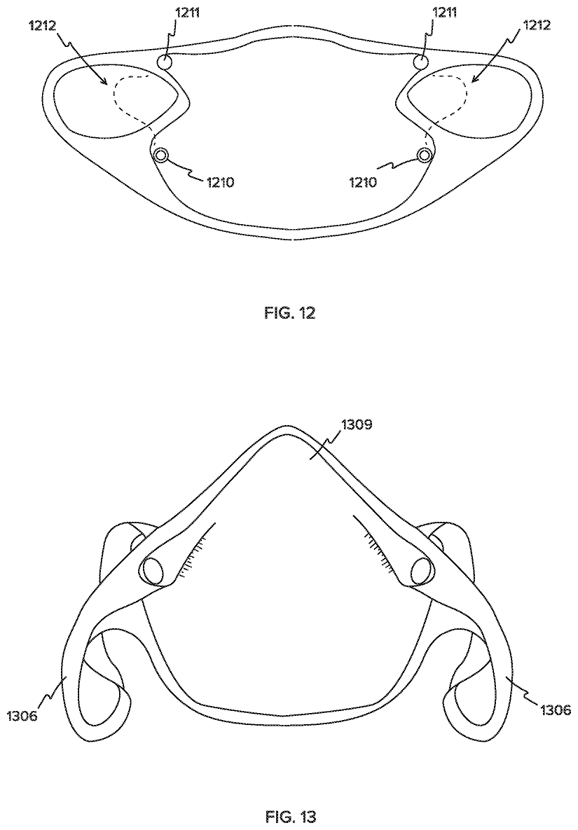

The resulting mask can be seen in FIG. 12. The upper button snap assembly 1211 can be releasably fastened to the lower button snap assembly 1210 by folding the edges of the mask so that the front of snap 1211 follows path 1212 to connect to the back of snap 1210. When folded in the manner, the resulting formed mask is seen in FIG. 13. The wearer places their thumb and forefinger inside of the ear loops, spreading the loops open, simultaneously places one loop around each ear and releases the loops to properly position the mask over the nose and chin, with the inner layer 1309 facing the wearer in contact with the skin.

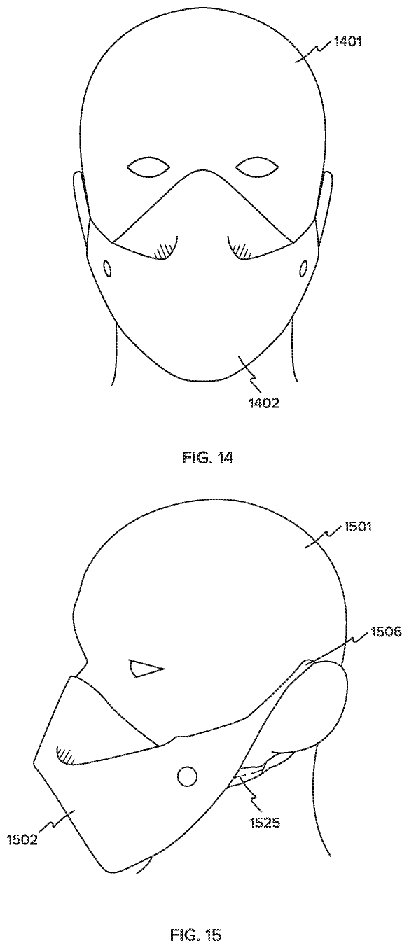

An additional embodiment of the mask is shown in FIG. 14 on the wearer 1401, where the inner layer is permanently connected to the outer layer 1402, similar to the previous embodiment of FIG. 9, however this mask has adjustable length ear loops. From the side view, the inner layer is not visible, but as seen in FIG. 15, the slits 1525 in the ear loop allow for the length of the ear loop straps 1506 to be adjusted to fit the mask 1502 to the wearer 1501.

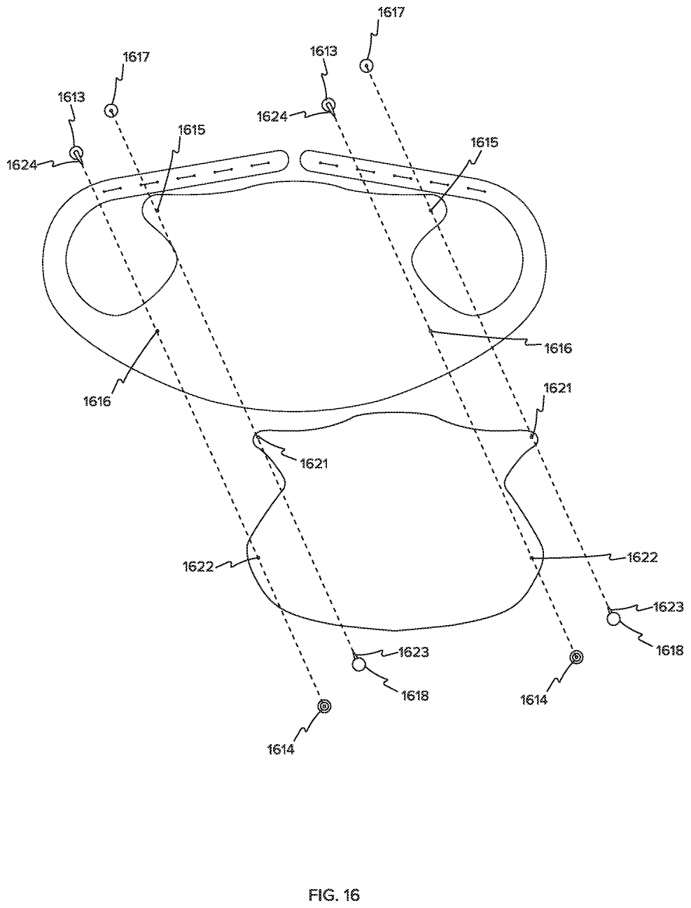

As seen in FIG. 16, this same embodiment can be viewed from the back as an exploded assembly to demonstrate the components of the fastening mechanism, shown here as button snaps. The button snaps are comprised of a small upper snap assembly and a large lower snap assembly that releasably fastening together. The upper assembly is formed by inserting the spike 1623 from the male component 1618 through the inner layer upper hole 1621, through the outer layer upper hole 1615, through the small female snap 1617 and pressing with an installation tool to deform the spike 1623 into a flat shape that cannot be withdrawn from the small female snap 1617. The lower assembly is formed by inserting the spike 1624 from the male component 1613 through the outer layer lower hole 1616, through the inner layer lower hole 1622, through the large female snap 1614 and pressing with an installation tool to deform the spike 1624 into a flat shape that cannot be withdrawn from the large female snap 1614. When assembled, the inner layer 1609 is permanently connected to the outer layer 1602.

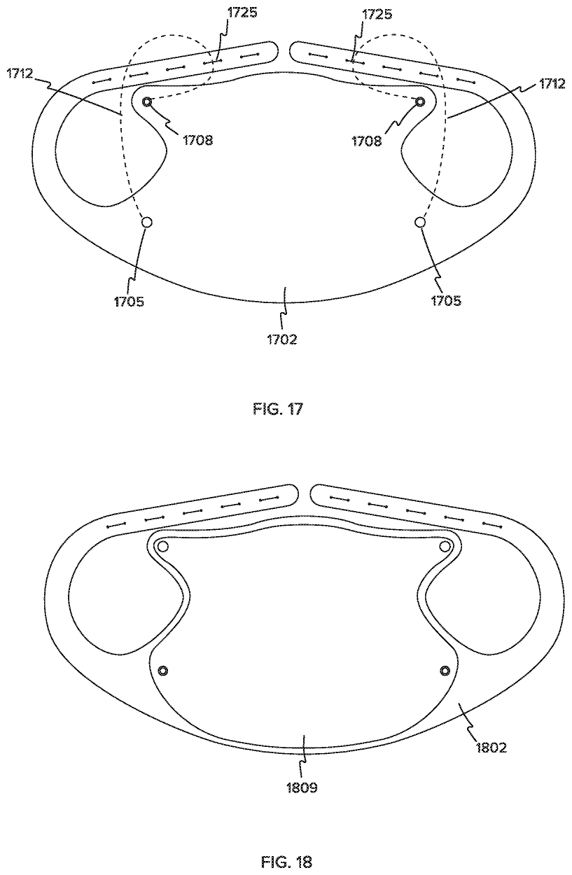

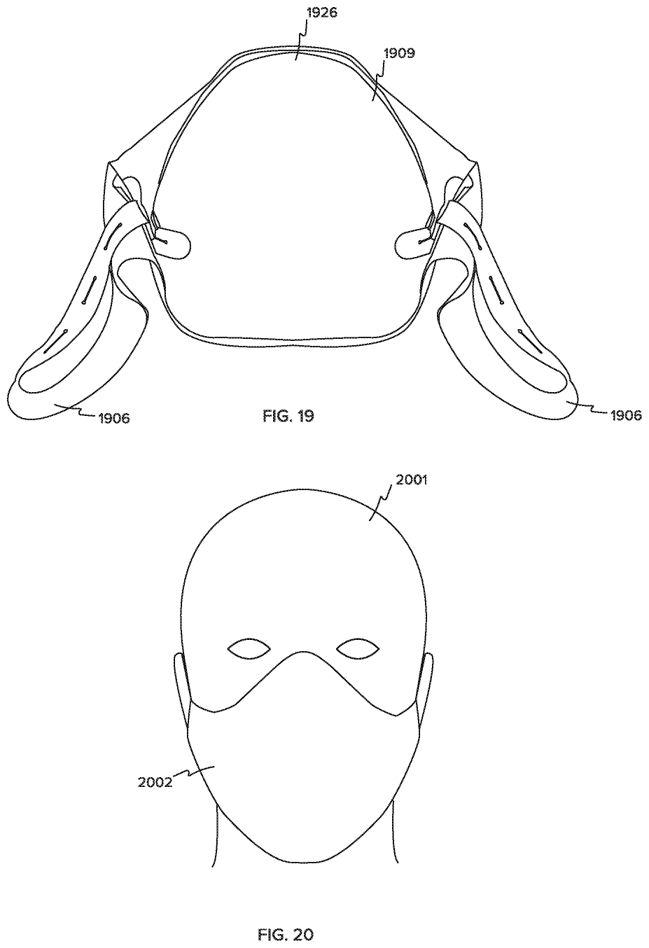

As seen in FIG. 17 when the mask is assembled, unfolded, and the outer layer 1702 is flat and viewed from the front, the inner layer is still not visible similar to FIG. 10. The upper button snap assembly 1708 can be releasably fastened to the lower button snap assembly 1705 by folding the edges of the mask so that the front of snap 1708 follows path 1712, is inserted through the slit 1725, and connects to the back of snap 1705. When folded in the manner, the resulting formed mask is seen in FIG. 19. The wearer places their thumb and forefinger inside of the ear loops 1906, spreading the loops open, simultaneously places one loop around each ear and releases the loops to properly position the mask over the nose and chin, with the inner layer 1909 facing the wearer in contact with the skin. The nose bridge 1926 is sculpted by the folding to conform to the shape of the nose.

A separate embodiment could have an outer layer, without an inner layer, and extend around the entire circumference of the head. With reference to FIG. 20, a person 2001 is shown wearing a mask 2002 that has an elastic outer layer.

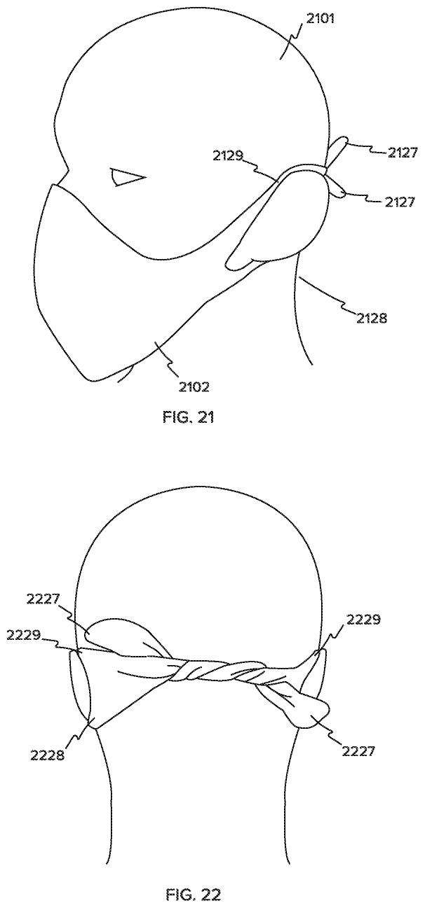

As seen in FIG. 21, the same mask 2102 shown on the side profile of the wearer 2101. An elongated hole in the sides of the mask 2102 has an upper section 2129 that fits above the ear and lower section 2128 that fits below the ear. The mask is secured to the face of the wearer 2101 by tying the ends 2127. A simple double twist in the ends is enough to hold the mask in place, as seen in FIG. 22. The upper ear section 2229 and lower ear section 2228 converge in the back of the head and the ends 2227 are connected by tying or twisting.

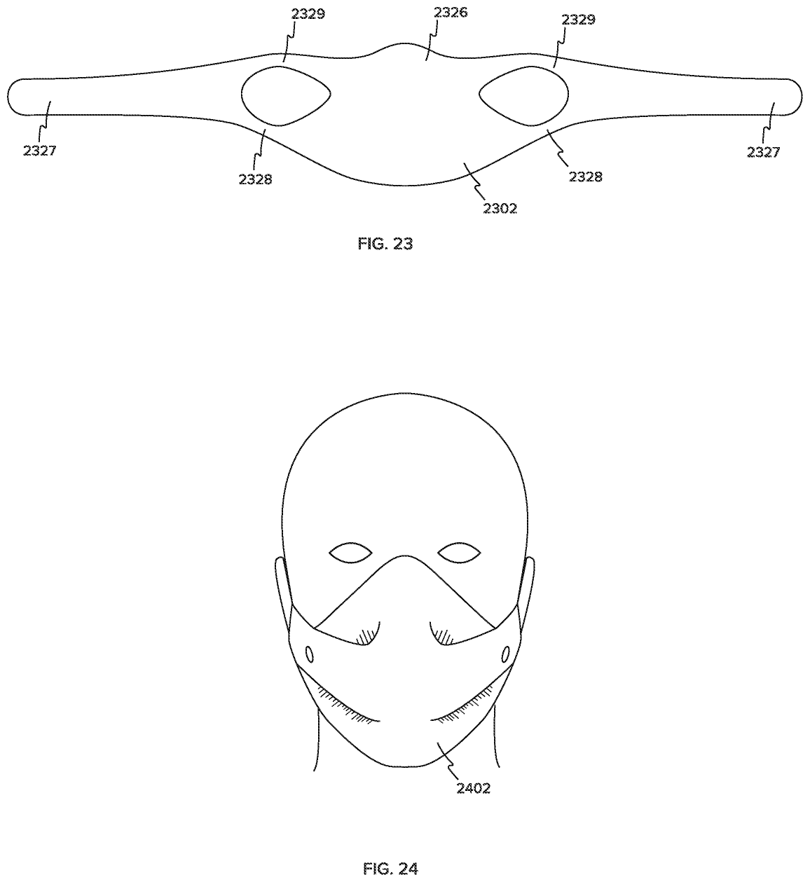

In FIG. 23, the front of the same embodiment of the mask outer layer 2302 is shown folded flat with the tieable ends 2327 fully extended outwards. The elongated ear holes in the layer create an upper ear section 2329 of the layer and a lower ear section 2328 of the layer. The middle of the mask 2302 has a rise 2326 in the outer profile to match the rise of the nose bridge of the wearer.

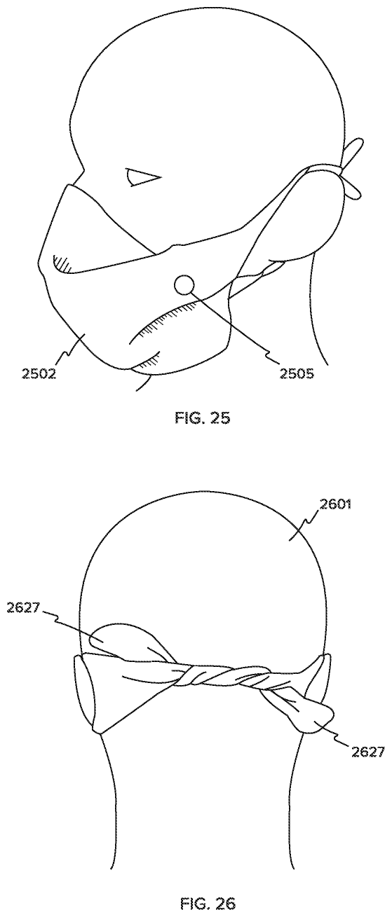

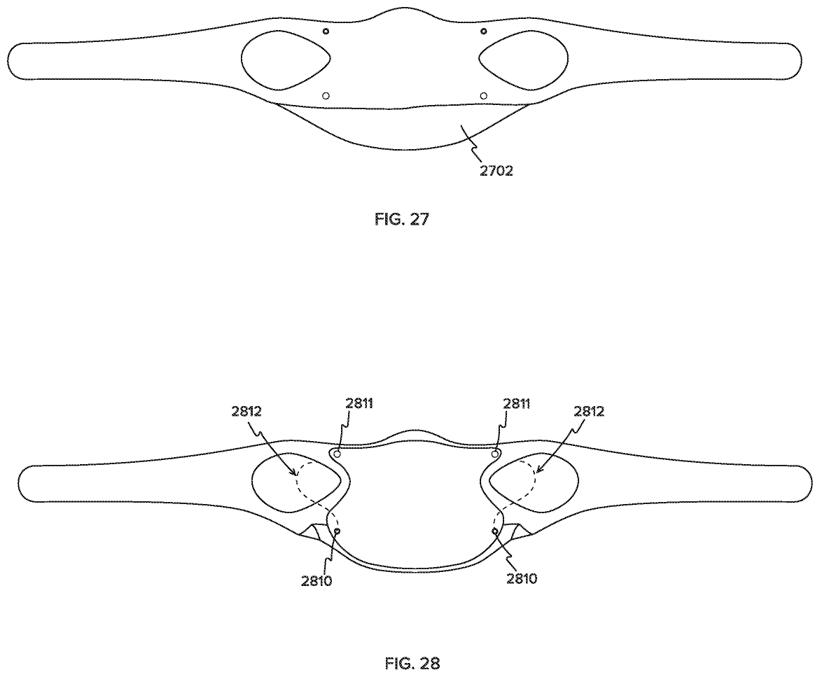

An additional embodiment of the mask, shown from the front in FIG. 24, has an outer semi-rigid layer 2502 and a permanently attached inner layer. Also seen from the side in FIG. 25, the use of a fastening mechanism 2505 for releasably folding the mask, also allows for the permanent attachment of the inner layer. When press fitting the fastener onto the mask, the inner layer can be trapped between the fastening mechanism and the outer layer. As seen from the back in FIG. 26, this mask can likewise be attached to the wearer 2601 with a simple twist of the ends 2627. FIG. 28 demonstrates the folding action of the fasteners for releasable fastening the mask in the folded position. The upper fastener 2811 is connected to the lower fastener 2810 via the path 2812, where the front of the upper fastener 2811 is connected to the back of the lower fastener 2810.

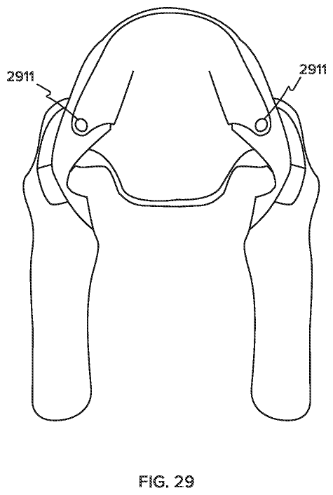

The resulting shape can be seen in FIG. 29, where the back of the upper fastener 2911 is visible. The position of the fastener on the mask can determine whether or not the folding creates a 180 degree twist in the ends. Without the twist, the mask would be very linear along the side of the face. With the twist, the chin section of the front of the mask would be pulled up toward the top of the ear and the nose section of the mask would be pulled down toward the bottom of the ear.

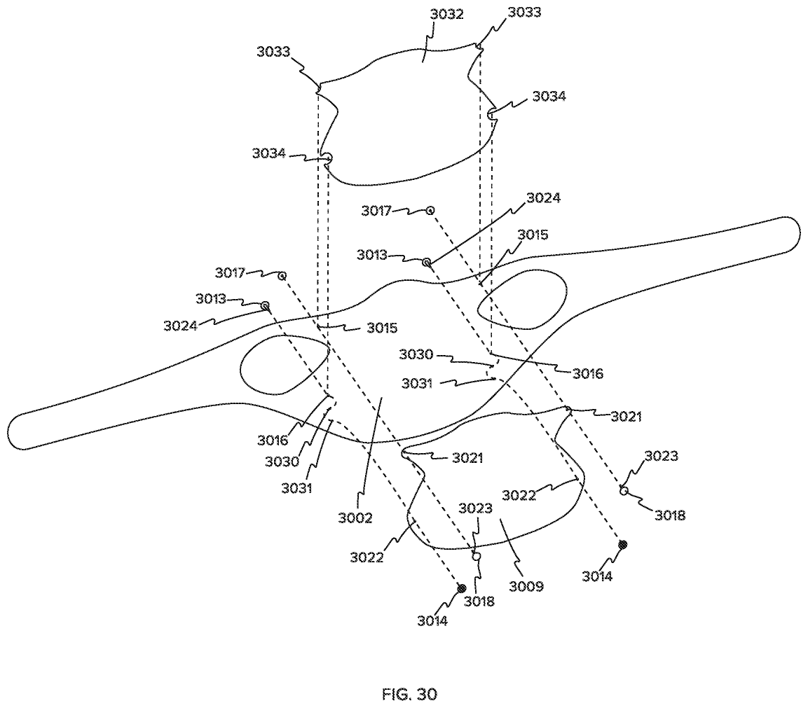

Multiple fasteners could also allow there to be an upper fold in the mask and a lower fold in the mask, to better shape the mask to the profile of the face and protect further under the chin. The lower fold could also be accomplished with only one fastener, if there were multiple holes that the fastener were assembled through. For instance, in the case of a button snap, the spike on the male component could pass through three holes spaced in the material to create a fold. This would provide an additional embodiment of the mask, as shown in FIG. 30.

The embodiment of FIG. 30 has a fastening mechanism, shown here as button snaps. The button snaps are comprised of a small upper snap assembly and a large lower snap assembly that releasably fastening together. The upper assembly is formed by inserting the spike 3023 from the male component 3018 through the inner layer upper hole 3021, through the outer layer upper hole 3015, through the small female snap 3017 and pressing with an installation tool to deform the spike 3023 into a flat shape that cannot be withdrawn from the small female snap 3017. The lower assembly is formed by inserting the spike 3024 from the male component 3013 through the outer layer first lower hole 3016, through the outer layer second lower hole 3030, through the outer layer third lower hold 3031, through the inner layer lower hole 3022, through the large female snap 3014 and pressing with an installation tool to deform the spike 3024 into a flat shape that cannot be withdrawn from the large female snap 3014. When assembled, the inner layer 3009 is permanently connected to the outer layer 13002.

Additionally, an optional replaceable filter layer 3032 can be added to the mask. This is inserted between the outer layer 3002 and the inner layer 3009. It is positioned, and remains in place during use, by use of notches that partially fit around the round button snaps, creating a loose mating on each notch, but a robust mating when combined. The upper notch 3033 fits around the upper button snap male 3018 and the lower notch 3034 fits around the lower snap male 3013.

What is claimed is:

1. A fastener formed face mask comprising:
a flat fabric article having a first end, a second end and a central axis;
a first fastener pair positioned between the first end and the central axis; and
a second fastener pair positioned opposite the first fastener pair between the second end and the central axis;
wherein the fastener formed face mask is predominantly flat in an unfastened position of both the first and second fastener pairs, and
wherein the fastener formed face mask is cupped for fitting to a face of a wearer in a fastened position of both the first and second fastener pairs.

2. The fastener formed face mask of claim 1, wherein the flat fabric article is formed from at least one of textiles, woven fabrics, non-woven fabrics, knit fabrics, double knit fabrics, elastic fabrics, inelastic fabrics, spandex, neoprene, denim, cotton twill, canvas, duck canvas, combed cotton, jersey, polyester, nylon, rayon, cotton, wool, polypropylene, spunbond polypropylene, melt blown polypropylene, polyurethane, polyisoprene, borosilicate fibers, or combinations thereof.

3. The fastener formed face mask of claim 1, wherein the first and second fastener pairs each include at least one of a snap fastener, a button and button hole, a hook and loop fastener, a rivet, a grommet, a screw set, stitching, velcro, adhesive, interference fit, or combinations thereof.

4. The fastener formed face mask of claim 1, further comprising:
a first ear hole defined in the flat fabric article proximate the first end and sized to fit around an ear of a wearer; and
a second ear hole defined in the flat fabric article proximate the second end and opposite the first ear hole and sized to fit around another ear of the wearer.

5. The fastener formed face mask of claim 4, wherein:
the first ear hole is elongated to accommodate a range of head sizes; and
the second ear hole is elongated to accommodate a range of head sizes.

6. The fastener formed face mask of claim 1, wherein the first and second end can be connected together by one or more of the following techniques: twist, fold, tie, clamp, crimp, snap, stitching, velcro, adhesive, interference fit, button and hole, zipper, hook and eye.

7. The fastener formed face mask of claim 1, wherein the flat fabric article is formed by at least one of die cutting, laser cutting, fabric cutting, digital cutting, die pressing, die rolling, or combinations thereof.

8. The fastener formed face mask of claim 1, further comprising a second fabric article including:
a first hole defined in the second fabric article and sized to be fastened to the flat fabric article by the first fastener pair; and
a second hole defined in the second fabric article and sized to be fastened to the flat fabric article by the second fastener pair.

9. The fastener formed face mask of claim 8, wherein, the second fabric article is predominantly flat in an unfastened position of both the first and second fastener pairs, and
the second fabric article is cupped for fitting to the face of the wearer in a fastened position of both the first and second fastener pairs.

10. The fastener formed face mask of claim 9, wherein the second fabric article is secured by the flat fabric article to the face of the wearer in the fastened position of both the first and second fastener pairs.

11. The fastener formed face mask of claim 8, wherein:
the second fabric article is cupped in an unfastened position of both the first and second fastener pairs, and
the second fabric article is secured by the flat fabric article to the face of the wearer in a fastened position of both the first and second fastener pairs.

12. The fastener formed face mask of claim 8, wherein the second fabric article is formed from at least one of textiles, woven fabrics, non-woven fabrics, elastic fabrics, inelastic fabrics, spandex, neoprene, denim, cotton twill, canvas, duck canvas, combed cotton, jersey, polyester, nylon, rayon, cotton, wool, polypropylene, spunbonded polypropylene, polyurethane, polyisoprene, borosilicate fibers, or combinations thereof.

13. The fastener formed face mask of claim 8, wherein the second fabric article is formed by at least one of die cutting, laser cutting, fabric cutting, digital cutting, die pressing, die rolling, or combinations thereof.

14. The fastener formed face mask of claim 1, wherein the first end and second end can be adjusted in length to accommodate a range of head sizes.

15. The fastener formed face mask of claim 14, wherein the size adjustment is accomplished with slits or holes in the fabric of the first end to allow the first fastener pair to releasably connect through; and slits or holes in the fabric of the second end to allow the second fastener pair to releasably connect through.

16. The fastener formed face mask of claim 1, wherein the first and second fastener pairs each are assembled through multiple layers of the flat fabric article to form one or more folds in the flat fabric article for cupping the mask further under the chin of the wearer.

17. An elastic face mask comprising:
a flat fabric article having a first end, a second end and a central axis;
a first elongated ear hole positioned between the first end and the central axis; and
a second elongated ear hole positioned opposite the first ear hole between the second end and the central axis;
wherein the elastic facemask is held in place by at least one of fabric tension between the tops of the ears and front of the face, fabric tension between the front of the face and the back of the head, the fabric tension between the tops of the ears and the back of the head, or a combination thereof.

18. The elastic face mask of claim 17, further comprising:
a first fastener pair positioned between the first end and the central axis; and
a second fastener pair positioned opposite the first fastener pair between the second end and the central axis;
wherein the elastic formed face mask is predominantly flat in an unfastened position of both the first and second fastener pairs, and
wherein the elastic formed face mask is cupped for fitting to a face of a wearer in a fastened position of both the first and second fastener pairs.

19. The elastic face mask of claim 18, wherein the first and second fastener pairs each include at least one of a snap fastener, a button and button hole, a hook and loop fastener, a rivet, a grommet, a screw set, stitching, velcro, adhesive, interference fit, or combinations thereof.

20. The elastic face mask of claim 18, further comprising a second fabric article including:
a first at least one hole defined in the second fabric article and sized to be fastened to the flat fabric article by the first fastener pair; and
a second at least one hole defined in the second fabric article and sized to be fastened to the flat fabric article by the second fastener pair.
